(19) United States
(12) Patent Application Publication
(10) Pub. No.: US 2009/0146470 A1
(43) Pub. Date: Jun. 11, 2009

(54) Vehicle seat

(75) Inventors: Gregory Thomas Thompson, Lawrenceville, GA (US); James Gregory Stanley, Novi, MI (US)

Correspondence Address: FOLEY AND LARDNER LLP;SUITE 500, 3000 K STREET NW, WASHINGTON, DC, 20007, US

(73) Assignee: TK HOLDINGS INC.

(21) Appl. No.: 12/232,824

(22) Filed: Sep. 24, 2008

Related U.S. Application Data
(60) Provisional application No. 60/960,306, filed on Sep. 25, 2007.

(51) Int. Cl. B60N 2/44; B60N 2/56

(52) U.S. Cl. 297/180.12; 297/217.3; 297/218.2; 297/452.48; 297/217.2

(57) ABSTRACT

A vehicle seat including a seat back and a seat bottom. The seat bottom includes a seat cushion covered by a trim covering material. The trim covering material is connected to a support structure embedded in the seat cushion. An electrically powered auxiliary device is located between the seat cushion and the trim covering material and is removably attached to the support structure.

### CROSS REFERENCE TO RELATED APPLICATIONS

This application claims priority to and the benefit of U.S. Provisional Patent Application No. 60/960,306 filed Sep. 25, 2007. The foregoing provisional application is incorporated by reference herein in its entirety.

### BACKGROUND

The present application relates generally to the field of vehicle seating. Vehicle seats may include electrically powered auxiliary components or devices such as seat heaters, occupant sensors, occupant classification systems, or seat belt reminders. Generally, these auxiliary components are permanently incorporated between the foam pad and seat trim. For example, an auxiliary component may be sewn into the seat trim. In these known systems, when a seat component or auxiliary component is damaged, it may be necessary to replace the component. However, because the auxiliary components are permanently attached to the seat foam or trim, more than one component may have to be replaced which increases the time and cost of replacement. Accordingly, there is a need for an attachment method for such components that allows the components to be independently serviced or replaced.

### SUMMARY

According to a disclosed embodiment, a vehicle seat is provided. The seat includes a seat back and a seat bottom. The seat bottom includes a seat cushion covered by a trim covering material. The seat also includes an electrically powered auxiliary device that is located between the seat cushion and the trim covering material and is removably attached to the seat bottom.

According to another disclosed embodiment, a vehicle seat is provided. The seat includes a seat back and a seat bottom including a seat cushion covered by a trim covering material. The trim covering material is connected to a support structure embedded in the seat cushion. The seat also includes an electrically powered auxiliary device located between the seat cushion and the trim covering material and removably attached to the support structure.

According to yet another disclosed embodiment, a vehicle seat is provided. The seat includes a seat back and a seat bottom. The seat bottom includes a foam seat cushion covered by a trim covering material. The trim covering material is connected to a wire embedded in the foam seat cushion. An electrically powered occupant sensing device is located between the seat cushion and the trim covering material and is removably attached to the wire.

It is to be understood that both the foregoing general description and the following detailed description are exemplary and explanatory only, and are not restrictive of the invention as claimed.

### BRIEF DESCRIPTION OF THE DRAWINGS

These and other features, aspects, and advantages of the present invention will become apparent from the following description, appended claims, and the accompanying exemplary embodiments shown in the drawings, which are briefly described below.

FIG. 1 is an isometric view of a vehicle seat.

FIG. 2 is a top view of a seat cushion.

FIG. 3 is a top view of one exemplary auxiliary device or component that is configured to be connected to a seat cushion.

FIG. 4 is a top view depicting the auxiliary device of FIG. 3 connected to the seat cushion.

FIG. 5 is a partial cross-sectional view of the seat cushion of FIG. 4 depicting a connection between the seat cushion and the auxiliary component or device.

FIG. 6 is a partial cross-sectional view of the seat cushion of FIG. 4 depicting an alternative type connection between the seat cushion and an auxiliary component or device.

FIG. 7 is a partial cross-sectional view of the seat cushion of FIG. 4 depicting another alternative type connection between the seat cushion and the auxiliary component or device.

### DETAILED DESCRIPTION

As described herein, according to one embodiment, a removable attachment system for a vehicle seat, includes a support frame included in the seat, a cushion including a fastener, coupled to the support frame, a cover, surrounding the cushion, attached to the fastener included in the cushion, and coupled to the support frame and an auxiliary component included between the cushion and the cover, wherein the auxiliary component is coupled to the fastener included in the cushion.

According to another embodiment, the auxiliary component further comprises tabs extending from the body of the auxiliary component, wherein the tabs are coupled to the fastener included in the cushion with at least one coupling member.

The coupling member may include a hog ring or a hook and loop type fastener. The cushion may include slits for positioning the auxiliary component between the cushion and the cover. The cushion may also include at least one embedded listing wire molded into trenches in the cushion. The cover may be attached to the fastener included in the cushion with hog rings or with hook and loop fasteners.

As described further below, the auxiliary component may be, for example, a seat heater, a an occupant sensing device, or a presence sensor for a seat belt reminder device.

According to one embodiment, a method for attaching the auxiliary component to a vehicle seat, includes providing a support frame included in the seat, providing a cushion including a fastener, coupled to the support frame, providing a cover, surrounding the cushion, attached to the fastener included in the cushion, and coupled to the support frame, positioning the auxiliary component between the cushion and the cover, and coupling the auxiliary component to the fastener included in the cushion.

The figures relate to a seat 10 (also can be referred to as a chair) particularly adapted for motor vehicles, such as cars, SUVs, vans, trucks, buses and the like. But the invention is also applicable to a seat 10 for use in aircraft, railroad vehicles, nautical vehicles, or other environments. The seat 10 may be configured as a split seat, a captain's chair or a bench type seat or any other type of seat 10 including a bucket-type seat 10 as shown in the Figures. The seat 10 as illustrated includes a seat back 11, a seat bottom 12, a framework 15 that is padded with foam 20 having certain contours, a trim cover 25 and the like. A wide variety of seat 10 configurations and appearances will benefit from use of the method for removable attachments as described below. Also, the exterior of the seat 10 can be covered by fabric, vinyl, leather or other known materials.

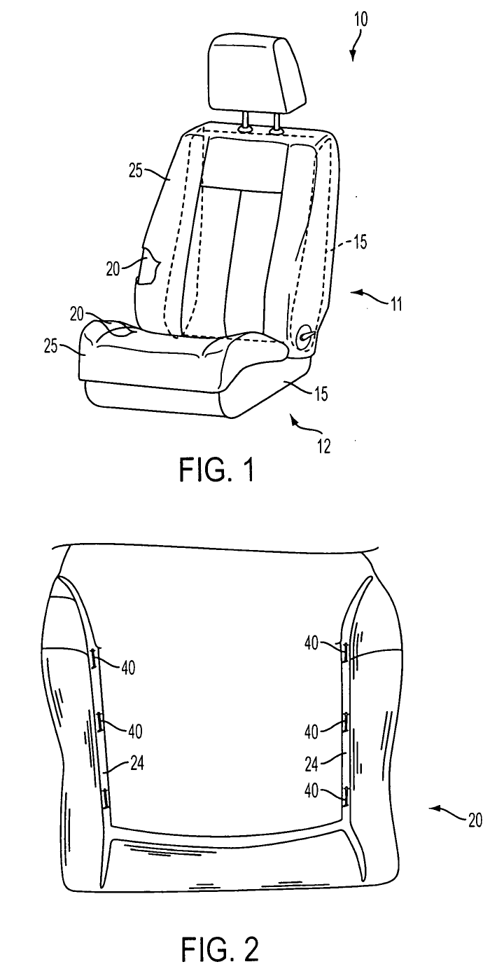

Referring to FIG. 1, a vehicle seat 10 is shown according to an exemplary embodiment. One or more seats 10 that are configured to receive an occupant may be provided in a vehicle. The vehicle seat 10 includes a generally horizontal lower portion or seat bottom 12 that is coupled to the vehicle and an upper portion or seat back 11 that extends upward from the rear end of the seat bottom. The seat back 11 may be connected to the seat bottom 12 through a recliner mechanism (not shown) that allows the seat back 11 to tilt or pivot relative to the seat bottom 12. Each of the seat bottom 12 and the seat back 11 include a supporting frame 15, a cushion 20 such as a foam pad that is coupled to the frame 15, and a trim cover 25 that surrounds the cushion 20. The trim cover 25 may attach to the foam pad 20 using a suitable fastener 30 (e.g., hook and loop fasteners, hog rings, other attachment methods molded into the foam pad, etc.). The trim cover 25 is also coupled to the frame structure 15 with a connection device or mechanism (e.g., with j-clips, etc.) that functions to couple the frame member 15, the trim cover 25, and the cushion 20 together.

The vehicle seat 10 further includes one or more auxiliary components 35. The auxiliary components 35 or devices are typically electrically powered and may be included in the vehicle seat 10 between the cushion/foam pad 20 and trim 25. These auxiliary components 35 include but are not limited to, seat heaters, occupant classification systems, or seat belt reminder systems. Generally, the auxiliary components 35 are attached to the seat cushion 20 or to the seat cover 25. For example, the auxiliary component 35 may be coupled directly to foam pad 20 or trim cover 25 with an adhesive, the auxiliary component 35 may be sewn into the trim cover 25, or tabs or other features on the auxiliary component 35 are inserted into apertures 22 in the foam pad 20.

Referring to FIGS. 2-4, the auxiliary components 35 are coupled to the foam pad 20 using the features already included in the foam pad 20 for attachment to the trim cover 25. As shown in FIG. 2, the seat cushion 20 includes one or more listing wires 40 molded into trenches 24 in the foam pad 20. The listing wires 40 are connected to corresponding features on the inside of the trim cover 25 with hog rings.

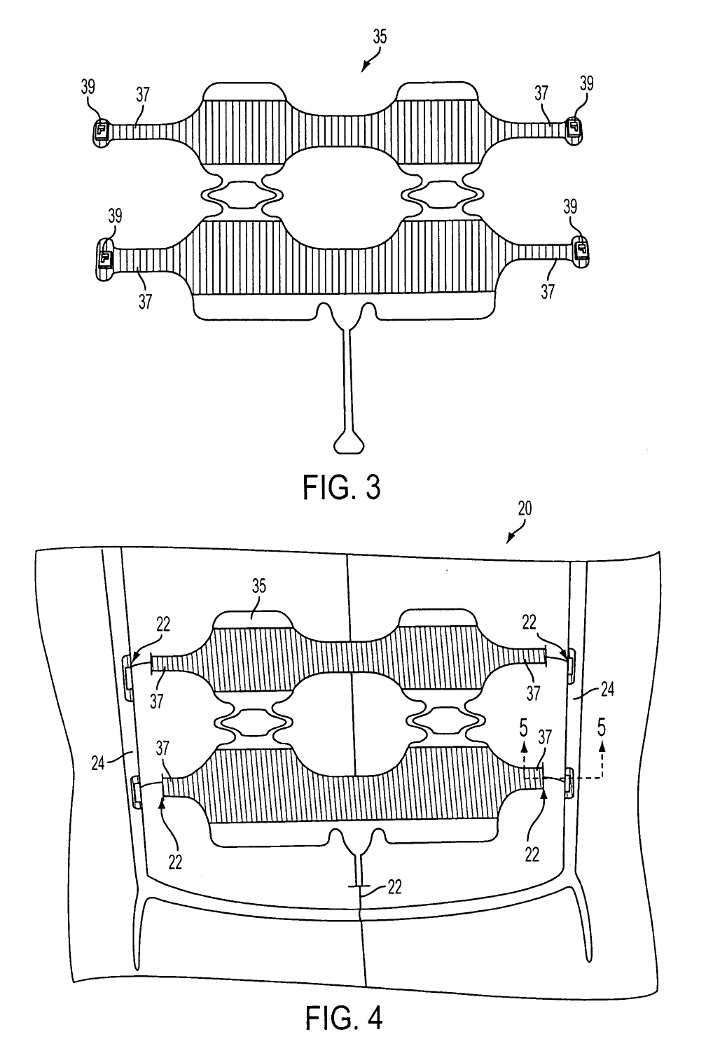

Referring now especially to FIGS. 3 and 4, the auxiliary component 35 is shown according to an exemplary embodiment as a portion of an occupant classification system. The auxiliary component 35 may be a sensing pad or mat used in conjunction with the classification system. The auxiliary component 35 includes tabs 37 which extend from the main body of the component 35. The tabs 37 are coupled to the listing wires 40 provided on the seat cushion 20 with coupling members 39, e.g., clips, attached to the tabs 37, by hog rings through holes in the tabs 37, or another suitable method. The auxiliary component or device is typically connected to a processor or control unit that is located outside the vehicle seat. Thus, the auxiliary component includes an electrical connection and conductor for carrying power and/or electronic signals between the component and the control unit.

As shown in FIG. 4, the foam pad 20 may include slits 22 or other features to facilitate positioning the auxiliary component 35 on the seat cushion 20. The auxiliary component 35 may include tapered portions or tabs 37 configured to fit securely within the slits 22 to thereby provide an additional retention mechanism for the auxiliary component.

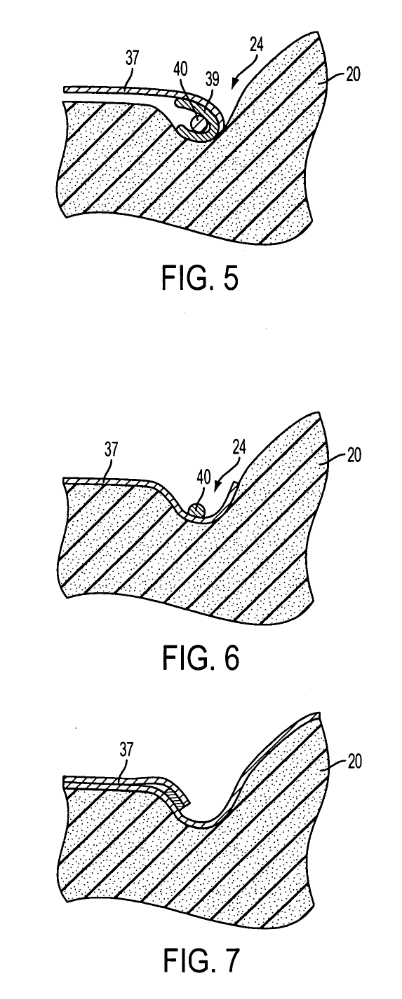

FIGS. 5 and 6 disclose two alternative embodiments for connecting the tabs 37 to the seat cushion 20. The tabs 37 may be connected to the listing wires 39 using a clip 39 as shown in FIG. 5. Alternatively, the tabs 37 may loop under the listing wires and be secured by the relatively tight connection and limited clearance between the cushion 20 and the wires 39, as shown in FIG. 6. FIG. 7 discloses that a hook and loop type attachment device 43. Alternatively, the tabs could be connected directly to the listing rods with hog rings. If necessary, the end of the tab could be reinforced with additional material to increase durability of the connection.

According to another exemplary embodiment, the trim cover 25 may be coupled to the foam pad 20 with hook and loop fasteners. The hook portion of the fasteners may be molded into the foam 20 and a webbing of loop portions may be sewn into the trim cover 25. The auxiliary component 35 includes tabs 37 that extend from the main body of the component 35. The ends of the tabs 37 may include a webbing of loop portions on one face and a webbing of hook portions on the opposite face. The tabs 37 engage the hook portions on the foam pad 20 to secure the component 35 in place. The hook portions engage the loop portions on the trim cover 25 to couple the trim cover 25 to the foam pad 20.

During the life of the vehicle seat 10, the auxiliary component 35 may require service or replacement. Removably securing the auxiliary component 35 to the vehicle seat 10 with a mechanism such as hog rings of hook and loop fasteners allows the auxiliary component 35 to be removed and/or replaced without having to replace another component such as the trim cover 25 if the component is adhered or sewn to the cover 25, which would increase the cost of the repair. Using the mechanisms that are already commonly used to coupled the trim cover 25 to the seat cushion 20 allows an auxiliary component 35 to be coupled to the seat cushion 20 without adding extra features or components to the foam pad 20 or modifying the foam pad 20. The coupling methods described above allow the auxiliary component 35 to be more easily independently serviced and/or replaced.

For purposes of this disclosure, the term “coupled” means the joining of two components (electrical or mechanical) directly or indirectly to one another. Such joining may be stationary in nature or movable in nature. Such joining may be achieved with the two components (electrical or mechanical) and any additional intermediate members being integrally formed as a single unitary body with one another or with the two components or the two components and any additional member being attached to one another. Such joining may be permanent in nature or alternatively may be removable or releasable in nature.

The construction and arrangement of the elements of the method for removable component as shown in the various exemplary embodiments is illustrative only. Although only a few embodiments of the present inventions have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited herein. For example, elements shown as integrally formed may be constructed of multiple parts or elements, the position of elements may be reversed or otherwise varied, and the nature or number of discrete elements or positions may be altered or varied. It should be noted that the elements and/or assemblies of the system may be constructed from any of a wide variety of materials that provide sufficient strength or durability. Components such as those shown herein may be used in non-vehicle applications as well. Other substitutions, modifications, changes and omissions may be made in the design, operating conditions and arrangement of the preferred and other exemplary embodiments without departing from the scope of the present invention.

What is claimed is:

1. A vehicle seat comprising:
a seat back; and
a seat bottom including a seat cushion covered by a trim covering material;
wherein an electrically powered auxiliary device is located between the seat cushion and the trim covering material and is removably attached to the seat bottom.

2. The seat of claim 1, wherein auxiliary device comprises a sensor for sensing the presence of an occupant of the seat.

3. The seat of claim 1, wherein the auxiliary device comprises a device for heating the vehicle seat.

4. The seat of claim 3, wherein the auxiliary device further comprises an occupant presence sensor.

5. The seat of claim 1, further comprising a second auxiliary electrically powered device located between the seat cushion and the trim covering material.

6. The seat of claim 1, wherein the auxiliary device is clipped to listing rods located in the seat cushion.

7. The seat of claim 1, wherein the auxiliary device is connected to the seat cushion by a hook and loop type attachment mechanism.

8. The seat of claim 1, wherein the auxiliary device includes tabs that are connected to a wire that is located in the seat cushion with hog rings.

9. The seat of claim 1, wherein the seat cushion comprises a foam material.

10. The seat of claim 9, wherein the foam material includes at least one slit and the auxiliary device includes a portion that is retained in the slit.

11. The seat of claim 1, wherein the trim covering material and the auxiliary device are connected to the same part of the seat cushion.

12. A vehicle seat comprising:
a seat back;
a seat bottom including a seat cushion covered by a trim covering material;
wherein the trim covering material is connected to a support structure embedded in the seat cushion; and
an electrically powered auxiliary device located between the seat cushion and the trim covering material and removably attached to the support structure.

13. The seat of claim 12, wherein the support structure includes a wire and the trim covering material and the auxiliary device are clipped to the wire.

14. The seat of claim 12, wherein the support structure includes a wire and wherein the trim covering material the auxiliary device includes tabs connected to the wire with hog rings.

15. The seat of claim 12, wherein the auxiliary device comprises a sensor pad for an occupant sensing system.

16. A seat for an occupant of a vehicle comprising:
a seat back;
a seat bottom including a foam seat cushion covered by a trim covering material, wherein the trim covering material is connected to a wire embedded in the foam seat cushion; and
an occupant sensing device located between the seat cushion and the trim covering material and removably attached to the wire.

17. The seat of claim 16, wherein the foam seat cushion include at least one slit and wherein a portion of the auxiliary device is retained within the slit.
